(19) United States
(12) Patent Application Publication
(10) Pub. No.: US 2015/0318672 A1
(43) Pub. Date: Nov. 5, 2015

(54) SPARK PLUG

(71) Applicant: NGK SPARK PLUG CO., LTD., Nagoya-shi (JP)

(72) Inventors: Yoshitomo IWASAKI, Nagoya-shi (JP); Haruki YOSHIDA, Gifu (JP)

(73) Assignee: NGK SPARK PLUG CO., LTD., Nagoya-shi (JP)

(21) Appl. No.: 14/700,508

(22) Filed: Apr. 30, 2015

(30) Foreign Application Priority Data
May 2, 2014 (JP) 2014-095105

(51) Int. Cl. H01T 13/41

(52) U.S. Cl. CPC H01T 13/41

(57) ABSTRACT

A spark plug includes an insulator with an axial through hole, a center electrode disposed in a front side of the through hole and a metal terminal disposed in a rear side of the through hole. The spark plug further includes a front conductive glass seal layer, a first resistor, a rear conductive glass seal layer, a seal contact member, a second resistor and a conductive elastic material arranged, in this order from the front to the rear, between the center electrode and the metal terminal within the through hole. The first resistor is formed containing at least a conductive material and a glass material. The second resistor is formed as a wire wound resistor having 30 or more turns of wire.

### FIELD OF THE INVENTION

The present invention relates to a spark plug.

### BACKGROUND OF THE INVENTION

As used hereinafter, the term “front” refers to a spark discharge side with respect to the direction of an axis of the spark plug; and the term “rear” refers to a side opposite the front side.

A spark plug for an internal combustion engine is widely used, in which a resistor is arranged between a center electrode and a metal terminal within a through hole of an insulator so as to suppress the radiation of radio noise (electromagnetic noise) to external equipment and improve the radio noise control performance of the spark plug. For manufacturing of such a resistor-equipped type spark plug, it has conventionally been proposed to form the resistor by filling and hot pressing a resistive glass composition in the through hole of the insulator or to form the resistor as a wire-wound resistor or a sintered ceramic resistor (see, for example, Japanese Laid-Open Patent Publication No. 2007-122879).

In recent years, there is a tendency to increase the discharge voltage of the spark plug. However, the increase of the discharge voltage leads to an increase in radio noise. Further, there is a tendency to inhibit the use of an iron-containing material as a vehicle component material for vehicle weight reduction even through iron has the properties to remove radio noise. The inhibition of the iron-containing material also leads to an increase in radio noise. For these reasons, the conventional resistor-equipped type spark plug may not be able to ensure sufficient radio noise control performance. It is desired to further improve the radio noise control performance of the spark plug.

Furthermore, the conventional resistor-equipped type spark plug has the following problems.

In the case where the resistor is formed by hot pressing the resistive glass composition, the spark plug attains excellent productivity and durability. In addition, the resistor properly performs its radio noise suppression function as the resistance of the resistor can be secured by the axial length of the resistor. The spark plug however increases in size and may deteriorate in ignition performance when the axial length of the resistor becomes increased to increase the resistance of the resistor and improve the radio noise control performance of the spark plug.

In the case where the resistor is formed as the wire-wound resistor, it is hard to secure (i.e., obtain) the sufficient resistance of the resistor even by increasing the number of wire turns of the resistor. Further, the durability of the resistor deteriorates with increase in the number of wire turns of the resistor. It is also hard to ensure sufficient contact between an inner wall surface of the insulator and an outer surface of the resistor in the case where the resistor is formed as the wire-wound resistor or the sintered ceramic resistor. When the contact between the inner wall surface of the insulator and the outer surface of the resistor is not sufficient, a short circuit occurs along the wall surface of the insulator to cause misfiring (flashover) at the time of spark discharge.

There has thus been a demand to develop a technique to effectively suppress radio noise without causing upsizing of the spark plug and deterioration in the durability and ignition performance of the spark plug.

### SUMMARY OF THE INVENTION

The present invention addressed the above and other problems and can be embodied by the following configurations.

### Configuration [1]

In accordance with a first aspect of the present invention, there is provided a spark plug comprising:

an insulator having a through hole formed therein in an axis direction;

a center electrode disposed in the through hole, with a front end portion of the center electrode protruding from a front end of the insulator;

a metal terminal disposed in the through hole, with a rear end portion of the metal terminal protruding from a rear end of the insulator;

a first resistor containing at least a conductive material and a glass material and located between the center electrode and the metal terminal within the through hole;

a pair of front and rear conductive glass seal layers located adjacent to front and rear ends of the first resistor, respectively;

a seal contact member located adjacent to a rear end of the rear conductive glass seal layer;

a second resistor located adjacent to a rear end of the seal contact member and provided in the form of a wire-wound resistor having 30 or more turns of wire; and

a conductive elastic member located between the second resistor and the metal terminal.

In configuration [1], the spark plug has two resistors: the first resistor formed containing the conductive material and the glass material; and the second resistor formed as the wire-wound resistor. It is possible by the combined use of these first and second resistors to effectively suppress radio noise while preventing upsizing of the spark plug and deterioration in the durability and ignition performance of the spark plug.

### Configuration [2]

In accordance with a second aspect of the present invention, there is provided a spark plug according to configuration [1], wherein the first resistor has a length of 3 mm to 12 mm in the axis direction.

It is possible in configuration [2] to more effectively suppress radio noise and increase the impact resistance of the spark plug.

### Configuration [3]

In accordance with a third aspect of the present invention, there is provided a spark plug according to configuration [1] or [2], wherein the second resistor has 100 turns or more of wire.

It is possible in configuration [3], even when the second resistor is not equipped with a ferromagnetic core to, more effectively suppress radio noise.

### Configuration [4]

In accordance with a fourth aspect of the present invention, there is provided a spark plug according to any configurations [1] to [3], wherein the second resistor has a core made of a ferromagnetic material and extending through the turns of the wire in the axis direction.

It is possible in configuration [4] to easily secure the high inductance component of the second resistor for more effective suppression of radio noise.

### Configuration [5]

In accordance with a fifth aspect of the present invention, there is provided a spark plug according to any configurations [1] to [4], wherein the ferromagnetic material contains iron oxide.

It is possible in configuration [5] to more effectively suppress radio noise.

### Configuration [6]

In accordance with a sixth aspect of the present invention, there is provided a spark plug according to any configurations [1] to [5], wherein a front end portion of the second resistor and a rear end portion of the seal contact member have respective engagement parts engageable with each other.

It is possible in configuration [6] to further improve the impact resistance of the spark plug.

### Configuration [7]

In accordance with a seventh aspect of the present invention, there is provided a spark plug according to any one of configurations [1] to [6], wherein the second resistor has a resistance of 1 kΩ or lower.

It is possible in configuration [7] to further improve the durability of the spark plug.

It is feasible to embody the present invention in various forms such as, not only a spark plug, but also an internal combustion engine with a spark plug, a vehicle having an internal combustion engine with a spark plug and a manufacturing method of a spark plug.

The other objects and features of the present invention will also become understood from the following description.

### BRIEF DESCRIPTION OF THE DRAWINGS

FIG. 1 is a section view of a spark plug according to one exemplary embodiment of the present invention.

FIG. 2 is a flow chart for a manufacturing method of the spark plug according to the exemplary embodiment of the present invention.

FIG. 3 is an enlarged schematic view of part of a spark plug according to a modification of the exemplary embodiment of the present invention.

FIG. 4 is a section view of a spark plug (sample of No. 6) used as a comparative example.

FIG. 5 is a section view of a spark plug (sample of No. 7) used as a comparative example.

### DETAILED DESCRIPTION OF THE PREFERRED EMBODIMENTS

The present invention will be described below with reference to the drawings.

### A. OVERALL STRUCTURE OF SPARK PLUG

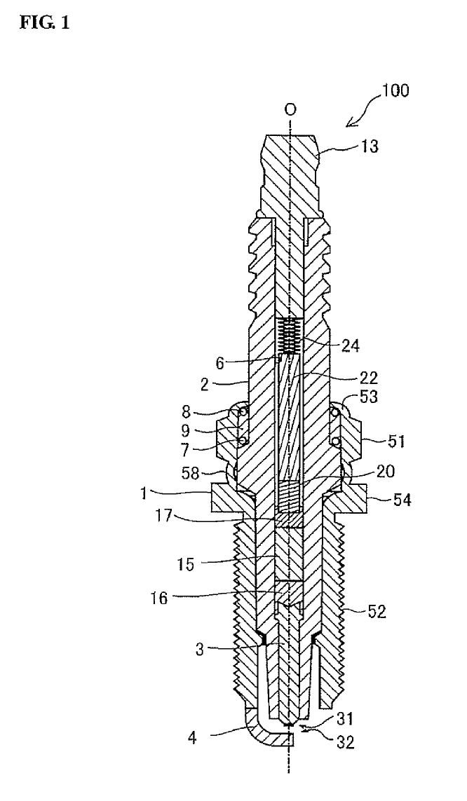

FIG. 1 is a schematic view of a spark plug 100 according to one exemplary embodiment of the present invention. As shown in FIG. 1, the spark plug 100 has an elongated shape along its axis O and includes a metal shell 1, a ceramic insulator 2 (as an insulator), a center electrode 3, a ground electrode 4, a metal terminal 13, first and second resistors 15 and 22, conductive glass seal layers 16 and 17, a seal contact member 20 and a conductive elastic member 24.

The ceramic insulator 2 is made of a sintered ceramic material such as alumina. A through hole 6 is formed through the ceramic insulator 2 in the direction of the axis O. The metal terminal 13 is partially inserted and fixed in a rear side of the trough hole 6, whereas the center electrode 3 is inserted and fixed in a front side of the through hole 6. The front conductive glass seal layer 16, the first resistor 15, the rear conductive glass seal layer 17, the seal contact member 20, the second resistor 22 and the conductive elastic member 24 are arranged, in this order from the front to the rear, between the center electrode 3 and the metal terminal 13 within the through hole 6 such that the center electrode 3 and the metal terminal 13 are electrically connected to each other through these structural members 16, 15, 17, 20, 22 and 24. (The structural members 16, 15, 17, 20, 22 and 24 will be explained in detail later.)

The metal shell 1 is cylindrical-shaped and arranged to surround a front part of the ceramic insulator 2 at a position apart from the metal terminal 13. In the present embodiment, the metal shell 1 is made of low carbon steel. The whole of the metal shell 1 may be coated with a plating of e.g. nickel or zinc. The metal shell 1 includes a tool engagement portion 51, a mounting thread portion 52 and a gasket receiving portion 54. The tool engagement portion 51 is formed to engage with a tool (not shown) for mounting the spark plug 100 to an engine head (not shown). The mounting thread portion 52 is formed with an external screw thread for screwing into a plug hole of the engine head. The gasket receiving portion 54 is formed, at a position in rear of the mounting thread portion 52, in a flanged shape protruding radially outwardly from the mounting thread portion 52. Although not specifically shown in the drawing, an annular gasket is fitted on a front end of the gasket receiving portion 54 so as to provide a seal between the metal shell 1 (gasket receiving portion 54) and the engine head in a state where the spark plug 100 is mounted to the engine head. The metal shell 1 also includes a thin crimped portion 53 formed in rear of the tool engagement portion 51 and a thin compression-deformed portion 58 formed between the tool engagement portion 51 and the gasket receiving portion 54 in the same manner as the crimped portion 53.

Annular ring members 7 and 8 are disposed between an inner circumferential surface of part of the metal shell 1 from the tool engagement portion 51 to the crimped portion 53 and an outer circumferential surface of the ceramic insulator 2. Further, a talc powder 9 is filled in between these ring members 7 and 8. During manufacturing of the spark plug 100, crimping is done to bend the crimped portion 53 inwardly and push the crimped portion 53 toward the front such that the compression-deformed portion 58 gets deformed with the application of a compression force from the crimped portion 53. By such crimping process, the ceramic insulator 2 is pressed toward the front within the metal shell 1 through the ring members 7 and 8 and the talc powder 9.

The metal terminal 13 is rod-shaped and disposed in the through hole 6 of the ceramic insulator 2, with a rear end portion of the metal terminal 13 protruding from a rear end of the ceramic insulator 2, for electrical connection to external equipment.

The center electrode 3 is rod-shaped and disposed in the through hole 6 of the ceramic insulator 2, with a front end portion of the center electrode 3 protruding from a front end of the ceramic insulator 2 and from a front end of the metal shell 1. A discharge part 31 is formed on the protruding front end portion of the center electrode 3 and exposed to the outside. In the present embodiment, the center electrode 3 has an electrode body made of a nickel alloy and a core made of copper or a copper alloy and embedded in the electrode body.

The ground electrode 4 is rod-shaped. A base end portion of the ground electrode 4 is welded to a front end face of the metal shell 1. A distal end portion of the ground electrode 4 is bent to a direction intersecting (perpendicular to) the axis O such that a lateral surface 32 of the distal end portion of the ground electrode 4 faces the discharge part 31 of the center electrode 3 on the axis O. There is defined a spark discharge gap between the discharge part 31 of the center electrode 3 and the lateral surface 32 of the ground electrode 4. With the application of a high voltage (e.g. 20,000 to 30,000 V) to the metal terminal 13, a spark discharge occurs within the spark discharge gap.

### B. STRUCTURAL MEMBERS INSIDE CERAMIC INSULATOR

As mentioned above, the conductive glass seal layer 16, the first resistor 15, the conductive glass seal layer 17, the seal contact member 20, the second resistor 22 and the conductive elastic member 24 are disposed between the center electrode 3 and the metal terminal 13 within the through hole 6 of the ceramic insulator 2. In particular, the present embodiment is characterized in that the first and second resistors 15 and 22 are arranged to suppress the radiation of radio noise at the time of spark discharge.

The conductive elastic member 24 is located between the metal terminal 13 and the second resistor 22 and formed of a conductive material so as to allow elastic deformation in the direction of the axis O and absorb not only variations in axial lengths of the structural members 16, 15, 17, 20 and 22 within the through hole 6 but also impact in the direction of the axis O for improvement in the impact resistance of the spark plug 100. In the present embodiment, the conductive elastic member 24 is provided in the form of a spring (more specifically, coil spring).

The conductive glass seal layers 16 and 17 are located adjacent to front and rear ends of the first resistor 15, respectively, and are formed of a mixture of a conductive material and a glass material so as to ensure air tightness in the through hole 6. As the conductive material, there can be used any of those containing, as a main constituent, at least one kind of metal selected from copper (Cu), iron (Fe), tin (Sn) and the like. As the glass material, there can be used at least one oxide-based glass selected from B₂O₃—SiO₂ glass, BaO—B₂O₃ glass, SiO₂—B₂O₃—CaO—BaO glass, SiO₂—ZnO—B₂O₃ glass, SiO₂—B₂O₃—Li₂O glass, SiO₂—B₂O₃—Li₂O—BaO glass and the like. A semiconductor material such as TiO₂ or an insulating material may be added to the conductive glass seal layers 16 and 17.

The first resistor 15 is formed of a mixture of a conductive material and an aggregate material that contains at least a glass material and optionally a ceramic material etc. As the conductive material, there can be used a powder of at least one material selected from metal and non-metal materials. Examples of the metal material are zinc (Zn), antimony (Sb), tin (Sn), silver (Ag) and nickel (Ni). Examples of the non-metal material are carbon materials such as carbon black and graphite, silicon carbide, titanium carbide, tungsten carbide and zirconium carbide. As the glass material, there can be used at least one oxide-based glass selected from B₂O₃—SiO₂ glass, BaO—B₂O₃ glass, SiO₂—B₂O₃—CaO—BaO glass, SiO₂—ZnO—B₂O₃ glass, SiO₂—B₂O₃—Li₂O glass, SiO₂—B₂O₃—Li₂O—BaO glass and the like. As the ceramic material, there can be used any of insulating ceramic materials such as alumina, silicon nitride, mullite and steatite and semiconductor oxide materials such as tin oxide. A binder may be added to the first resistor 15. As the binder, there can be used an organic binder such as polycarboxylic acid.

Preferably, the length of the first resistor 15 in the direction of the axis O (hereinafter sometimes referred to as “axial length”) is set to 3 mm or lager. When the axial length of the first resistor 15 is 3 mm or lager, it is possible to suppress the passage of electric current through the insulating material part of the first resistor 15 for improvement in radio noise suppression function (also called “radio noise control performance”).

Further, the length of the first resistor 15 in the direction of the axis O is preferably set to 12 mm or smaller, more preferably 8 mm or smaller. As will be described later, the first resistor 15 is formed by filling and compacting the raw material powder in the through hole 6 of the ceramic insulator 2. There is likely to occur a variation in the axial length of the first resistor 15 as the axial length of the first resistor 15 is increased. If the axial length of the first resistor 15 is increased due to the length variation, the degree of compression of the conductive elastic member 24 increases so that the impact absorbing function of the conductive elastic member 24 becomes weak. This leads to a deterioration in the impact resistance of the spark plug 100. If the length of the first resistor 15 is decreased due to the length variation, on the other hand, the degree of compression of the conductive elastic member 24 decreases so that the conductive elastic member 24 increases in length and becomes easy to bend under a vibrational load and thereby cause poor contact between the metal terminal 13 and the conductive elastic member 24 and between the second resistor 22 and the conductive elastic member 24. This also leads to a deterioration in the impact resistance of the spark plug 100. The upper limit of the length of the first resistor 15 is thus preferably set to the above value.

It is herein noted that the length of the first resistor 15 in the direction of the axis O refers to a distance from an rearmost point on a boundary between the first resistor 15 and the conductive glass seal layer 16 to a frontmost point on a boundary between the first resistor 15 and the conductive glass seal layer 17 in the direction of the axis O.

The seal contact member 20 is made of a metal material in a substantially cylindrical column shape and located adjacent to a rear end of the rear conductive glass seal layer 17. During manufacturing of the spark plug 100, the seal contact member 20 is placed in the through hole 6 of the ceramic insulator 2 after the filling of the respective raw material powders of the conductive glass seal layer 16, the first resistor 15 and the conductive glass seal layer 17 in the through hole 6, and then, pressurized in the direction of the axis O under heating. Namely, the seal contact member 20 is adapted to apply pressure to the conductive glass seal layer 17, the first resistor 15 and the conductive glass seal layer 16 and increase the density of these respective structural members 15, 16 and 17 for improvement in the durability of the spark plug 100. In the pressurizing and heating process, the seal contact member 20 is adhered to the conductive glass seal layer 17 so as to suppress the resistance between the seal contact member 20 and the conductive glass seal layer 17 and prevent the internal resistance of the spark plug 100 from exceeding a desired value.

The second resistor 22 is provided in the form of a wire-wound resistor and located adjacent to a rear end of the seal contact member 20. In the present embodiment, the second resistor 22 (wire-wound resistor) is comprised of a substantially cylindrical column-shaped core and a wire wound helically around a surface of the core such that the core pass through the turns of the wire in the direction of the axis O. By the use of such a second resistor 22, it is possible to secure the inductance component and improve the radio noise control performance of the spark plug 100.

It suffices that the number of turns of the wire in the second resistor 22 is 30 or more for effective suppression of radio noise. The inductance component of the second resistor 22 increases with increase in the number of turns of the wire in the second resistor 22. However, it is necessary to decrease the diameter of the wire in order to increase the number of turns of the wire in the second resistor 22. It becomes likely that the wire will be broken as the diameter of the wire is decreased. For this reason, the impact resistance and durability of the second resistor 22 may deteriorate if the number of turns of the wire in the second resistor 22 becomes too large. The number of turns of the wire in the second resistor 22 is thus preferably set to e.g. 500 or less.

It is herein noted that the number of turns of the wire in the second resistor 22 refers to the number of points of the helically wound wire overlapping in position with a starting point of the wound wire in the direction of the axis O.

In order to prevent breakage of the wire of the second resistor 22 and ensure the impact resistance and durability of the spark plug 100, the diameter of the wire of the second resistor 22 is preferably set to 2 μm or larger, more preferably 3 μm or larger, still more preferably 5 μm or larger. Further, the diameter of the wire of the second resistor 22 is preferably set to e.g. 50 μm or smaller, more preferably 40 μm or smaller, in order to ensure the required number of turns of the wire without excessive upsizing of the second resistor 22.

In order to control the wire turn number and the wire diameter to within the above preferable ranges, the length of the second resistor 22 in the direction of the axis O (hereinafter sometimes referred to as “axial length”) is preferably set to 3 mm or longer, more preferably 5 mm or longer. There is no particular limitation on the upper limit of the axial length of the second resistor 22. The length of the second resistor 22 in the direction of the axis O is preferably set to e.g. 15 mm or shorter, more preferably 10 mm or shorter, in order to limit upsizing of the spark plug 100.

It is herein noted that the length of the second resistor 22 in the direction of the axis O refers to a distance, in the direction of the axis O, between frontmost and rearmost points of the wire wound around the core.

The outer diameter of the core of the second resistor 22 is preferably set to 1.5 mm or larger, more preferably 2.0 mm or larger. It is easier to secure the inductance component of the second resistor 22 as the outer diameter of the core is increased. However, it is hard to place the second resistor 22 in the through hole 6 of the ceramic insulator 2 if the outer diameter of the core becomes too large. The outer diameter of the core is thus set to within such a range that the second resistor 22 (in which the wire is wound helically around the core) can be placed in the through hole 6.

The core of the second resistor 22 is preferably made using a ferromagnetic material such that the second resistor 22, even when formed with a less number of wire turns, can secure sufficient inductance component to improve in radio noise control performance. The ferromagnetic material refers to a magnetic material in which adjacent spins are aligned parallel to each other in the same direction to exhibit spontaneous magnetization. Examples of the ferromagnetic material are iron, cobalt, nickel, stainless steel (SUS) and ferromagnetic materials containing iron oxide (such as ceramic material e.g. ferrite). Among others, preferred are manganese-zinc (Mn—Zn) ferrite, nickel-zinc (Ni—Zn) ferrite and copper-zinc (Cu—Zn) ferrite. Particularly preferred are Mn—Zn ferrite and Ni—Zn ferrite.

In the case where the core of the second resistor 22 is made of any material other than the ferromagnetic material, it is preferable that the number of turns of the wire in the second resistor 22 is set to e.g. 100 or more in order to secure the sufficient inductance component of the second resistor 22.

Furthermore, the resistance of the second resistor 22 is preferably set to 1 kΩ or lower, more preferably 500Ω or lower, still more preferably 100Ω or lower, as measured at 20° C. When the resistance of the second resistor 22 is in the above range, it is possible to prevent degradation or breakage of the wire caused by heat generation of the second resistor 22 and suppress the passage of electric current between the adjacent wire turns of the second resistor 22 for improvement in the durability of the spark plug 100.

### C. MANUFACTURING METHOD OF SPARK PLUG

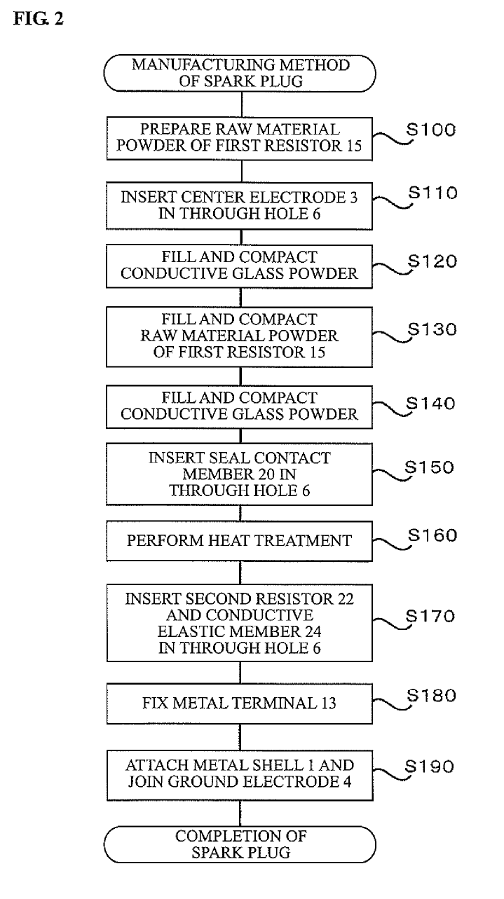

FIG. 2 is a flow chart showing one example of manufacturing method of the spark plug 100.

First, the raw material powder of the first resistor 15 is prepared (step S100). More specifically, powders of the constituent materials (such as conductive material and binder), except the glass material, are mixed with each other. The mixing can be done by e.g. wet ball milling and high shear mixing for adequate dispersion of the powders. The resulting mixed powder is subjected to size enlargement by spray drying, followed by adding thereto a powder of the glass material and water. The thus-obtained mixture is mixed well and dried. By this, the raw material powder of the first resistor 15 is obtained.

Next, the center electrode 3 is inserted in the through hole 6 of the ceramic insulator 2 (step S110).

In this state, the raw material powder of the conductive glass seal layer 16 (i.e. the mixed powder containing the conductive material and the glass material; hereinafter sometimes referred to as “conductive glass powder”) is filled into the through hole 6 from the rear side and then compacted (step S120). The compacting can be done by e.g. inserting a rod-shaped jig in the through hole 6 and pushing the filled conductive glass powder to the front side. The resulting powder layer is completed as the conductive glass seal layer 16 by the after-mentioned heat treatment process.

Subsequently, the above-prepared raw material powder of the first resistor 15 is filled into the though hole 6 from the rear side and then compacted (step S130). The resulting powder layer is completed as the first resistor 15 by the after-mentioned heat treatment process.

After that, the raw material powder of the conductive glass seal layer 16 (i.e. the mixed powder containing the conductive material and the glass material; hereinafter sometimes referred to as “conductive glass powder”) is filled into the though hole 6 from the rear side and then compacted (step S140). The resulting powder layer is also completed as the conductive glass seal layer 17 by the after-mentioned heat treatment process.

It is herein noted that: the conductive glass powder used in step S140 can be the same as the conductive glass powder used in step S120; and, in steps S130 and S140, the compacting can be done in the same manner as in step S120. The axial length of the first resistor 15 can be controlled by adjusting the amount of the raw material powder of the first resistor 15 filled in the through hole 6.

The seal contact member 20 is then inserted in the through hole 6 from the rear side (step S150) so as to push the above-formed powder layers to the front side.

The thus-obtained subassembly unit of the ceramic insulator 20 is heated at a predetermined temperature of 700 to 950° C. in a heating furnace (step S160) such that the glass materials of the respective power layers are melt to seal the inside of the through hole 6.

After the heat treatment process, the second resistor 22 and the conductive elastic member 24 are inserted, in this order, in the through hole 6 from the rear side (step S170).

Then, the metal terminal 13 is fixed in the rear side of the through hole 6 and connected to the center electrode 3 through the structural members 16, 15, 17, 20, 22 and 24 (step S180).

Finally, the spark plug 100 is completed by attaching the metal shell 1 to the ceramic insulator 2 and joining the ground electrode 4 to the metal shell 1 (step S190).

As described above, the spark plug 100 is characterized by having two resistors: the first resistor 15 formed containing the conductive material and the glass material; and the second resistor 22 formed as the wire-wound resistor. In this configuration, the spark plug 100 can secure resistance by the first resistor 15 and secure inductance component by the second resistor 22. It is therefore possible to effectively suppress the radiation of radio noise and improve the radio noise control performance of the spark plug 100.

It is a novel finding of the present inventors that it is possible by sufficiently securing not only the resistance but also the inductance component to improve the radio noise control performance of the spark plug 100.

In general, the radio noise control performance of a spark plug tends to be improved as the capacitance component of a resistor of decreases with increase in the resistance of the resistor (the axial length of the resistor) in the spark plug. When the resistance of the resistor becomes too high, there arises various problems such as upsizing of the spark plug, deterioration in the ignition performance of the spark plug, the demand for a higher voltage for the spark discharge etc.

In the case of using only the first resistor 15 (formed containing the conductive material and the glass material), the variation in the axial length of the first resistor 15 increases with increase in the axial length of the first resistor 15. If the axial length of the first resistor 15 made longer than a design value due to the length variation, the degree of compression of the conductive elastic member 24 increases so that the impact absorbing function of the conductive elastic member 24 becomes weak. If the length of the first resistor 15 is made shorter than a design value due to the length variation, the degree of compression of the conductive elastic member 24 decreases so that the conductive elastic member 24 increases in length and becomes easy to bend under a vibrational load and cause poor contact between the metal terminal 13 and the conductive elastic member 24 and between the second resistor 22 and the conductive elastic member 24. Consequently, the spark plug 100 may deteriorate in impact resistance.

In the case of using only the second resistor 22 (formed as the wire-wound resistor), the axial length of the second resistor 22 can be secured more accurately than the first resistor 15. Even when the axial length of the second resistor 22 is increased to a certain value, however, the spark plug 100 may not secure sufficient resistance to suppress radio noise. Further, it is hard to ensure sufficient contact between an inner wall surface of through hole 6 of the ceramic insulator 2 and an outer surface of the second resistor 22. Flashover (i.e. short circuit along the wall surface of the through hole 6) occurs when the contact between the ceramic insulator 2 and the second resistor 22 becomes insufficient. The spark plug 100 may consequently deteriorate in radio noise control performance or ignition performance.

In the present embodiment, by contrast, the spark plug 100 is provided with the first and second resistors 15 and 22 so as to secure the resistance by the first resistor 15 and secure the inductance component by the second resistor 22. Even when the total resistor resistance is set lower than a conventional value, the spark plug 100 achieves sufficiently high radio noise control performance without the above-mentioned problems caused by too high resistor resistance. As compared to the case of using only the first resistor 15, the axial length of the first resistor 15 can be limited so as to suppress the variation in the axial length of the first resistor 15 by the combined use of the first and second resistors 15 and 22 in the present embodiment. Further, the first resistor 15 can be formed by compacting and heating the glass-containing raw material powder in the through hole 6 so as to ensure intimate contact between the inner wall surface of the through hole 6 and the outer surface of the first resistor 15 and prevent the occurrence of flashover even when the sufficient resistance is secured by the first resistor 15. The spark plug 100 thus achieves improved impact resistance and prevents deterioration in ignition performance.

In particular, the number of turns of the wire in the second resistor 22 is set to 30 or more in the present embodiment. The inductance component of the second resistor 22 can be thus increased to a sufficiently high value while limiting the resistance of the first resistor 15.

Moreover, the first resistor 15 is located in front of the second resistor 22 such that the second resistor 22 is placed in the through hole 6 after the heat treatment process for the formation of the first resistor 15. This allows, during manufacturing of the spark plug 100, a reduction of the amount of heat applied to the second resistor 22 so as to prevent degradation or breakage of the wire caused by such heat application and improve the durability of the spark plug 100. As a result, the diameter of the wire of the second resistor 22 can be decreased so as to increase the number of turns of the wire per unit length in the direction of the axis O and secure the higher inductance component of the second resistor 22.

### D. MODIFICATIONS

The present invention is not limited to the above specific embodiment. For example, the following modifications are possible.

### First Modification Example

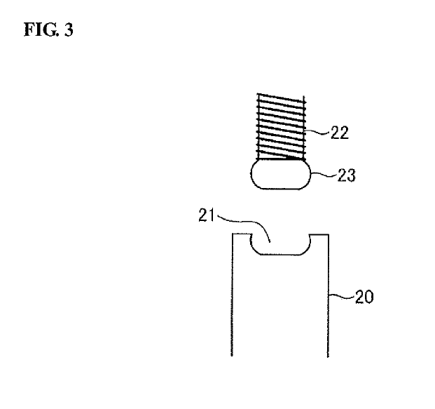

FIG. 3 is an enlarged schematic view of part of a spark plug according to a first modification example of the above exemplary embodiment of the present invention. The spark plug of the first modification example is structurally the same as the spark plug 100, except for the connection between the seal contact member 20 and the second resistor 22. In the following description, the same parts and portions as those in the above exemplary embodiment are designated by the same reference numerals; and a detailed explanation thereof shall be omitted herefrom. In FIG. 3, only the seal contact member 20 and the second resistor 22 (before engagement) are shown by enlargement.

As shown in FIG. 3, a concave engagement part 21 is formed in a rear end portion of the seal contact member 20; and a convex engagement part 23 is formed on a front end portion of the core of the second resistor 22. The second resistor 22 is fixed to the seal contact member 20 by engagement of the convex engagement part 23 in the concave engagement part 21 during manufacturing of the spark plug. It is thus possible to increase the reliability of the connection between the seal contact member 20 and the second resistor 22 and improve the impact resistance of the spark plug.

Although the engagement parts 21 and 23 are formed in a concave shape and in a convex shape, respectively, in the first modification example, the engagement parts 21 and 22 are not limited to such configurations. It is alternatively feasible to form the engagement part 21 in a convex shape and form the engagement part 23 in a concave shape. As another alternative, the engagement parts 21 and 23 may be formed to provide screw connection between the seal contact member 20 and the second resistor 22.

### Second Modification Example

Although each of the conductive glass seal layers 16 and 17 is formed by preparing, compacting and heating the conductive glass powder in the above exemplary embodiment, the conductive glass seal layers 16 and 17 may be formed by a different method. Even in such a case, it is possible to obtain the same effects as in the above exemplary embodiment as long as the spark plug has the first and second resistors 15 and 22 and attains the sufficient sealability of the conductive glass seal layer 16, 17.

### E. EXAMPLES

The present invention will be described in more detail below by way of the following examples.

Various samples of spark plugs were produced by changing the configurations of resistors. The durability, radio noise control performance and impact resistance of the respective spark plug samples were examined as follows.

### Durability Test

Each of the spark plug samples was subjected to acceleration experiment in a desktop spark tester. More specifically, a discharge voltage of 20 kV was continuously applied at 60 Hz to the spark plug sample in an atmosphere of 300° C. The resistance of the respective spark plug samples was measured at 20° C. every 6 hours of discharge test. Then, the resistance change rate of the spark plug sample was calculated by {(R1−R0)/R0}×100(%) where R0 is the resistance of the spark plug sample measured before the application of the discharge voltage; and R1 is resistance of the spark plug sample measured after the application of the discharge voltage. It can be said that, the smaller the resistance change rate after the lapse of a predetermined time and the longer the time elapsed until the resistance change rate reaches a predetermined level, the higher the durability of the spark plug. According to the following criteria (1) and (2), the durability of the spark plug sample was evaluated based on the calculation result.

(1) The spark plug sample was given a score of 10 points when the resistance change rate of the spark plug sample after 60 hours of discharge test was ±30%.

(2) In the case where the resistance change rate of the spark plug sample after 60 hours of discharge test was not within the range of ±30%, the score of the spark plug was subtracted by 1 point for every 6 hours decrease in the time elapsed until the resistance change rate reached the range of ±30%.

For example, the spark plug sample was given a score of 9 points when the resistance change rate exceeded ±30% after 60 hours of discharge test but fell within the range of ±30% after 54 hours of discharge test. The score of the spark plug sample was 0 (zero) point when the resistance change rate exceeded ±30% after 6 hours of discharge test.

### Radio Noise Control Performance Test

The spark plug samples, 5 samples for each type having substantially the same resistance (5±0.5 kΩ), were tested for the radio noise suppression function at 100 MHz by radio noise evaluation test according to JASO D002-2. The degree of improvement in the radio noise suppression function of the spark plug sample relative to that of a reference sample (hereinafter just referred to as “improvement degree”) was determined by calculating an average value of the test results of the five spark plug samples for each type and comparing the calculated average value with the test result of the reference sample. The reference sample use herein was a spark plug provided with only the first resistor 15 (provided with no second resistor 22) and having a resistance of 5 kΩ. According to the following criteria (1) to (3), the radio noise control performance of the spark plug sample was evaluated based on the comparison result.

(1) The spark plug sample was given a score of 10 points when the improvement degree of the spark plug sample was 10 dB or more.

(2) The spark plug sample was given a score of 9 points when the improvement degree of the spark plug sample was 9 dB or more and less than 10 dB.

(3) In the case where the improvement degree of the spark plug sample was less than 9 dB, the score of the spark plug sample was deducted by 1 point for every 1 dB decrease in the improvement degree of the spark plug sample.

### Impact Resistance Test

The spark plug samples, 10 samples for each type, was subjected to impact resistance test by applying an impact with a stroke of 22 mm for 10 minutes at a rate of 400 times per minute according to paragraph 7.4 of JIS B 8031 (2006). After the impact resistance test, the resistance of the respective spark plug samples was measured to determine how many samples for each type had an abnormal resistance. The abnormal resistance used herein was a value indicating the occurrence of disconnection in the spark plug sample. This abnormal resistance value was completely different in order of magnitude from the normal resistance value and thus was easily identified. According to the following criteria (1) to (4), the impact resistance of the spark plug sample was evaluated based on the measurement result.

(1) The spark plug sample was given a score of (zero) point when one or more out of the ten spark plug samples had an abnormal resistance after the impact resistance test.

(2) In the case where none of the ten spark plug samples had an abnormal resistance after the impact resistance test, the spark plug samples were additionally subjected to the same impact resistance test for 30 minutes. The spark plug sample was given a score of 3 points when one or more out of the ten spark plug samples had an abnormal resistance after the additional impact resistance test.

(3) In the case where none of the ten spark plug samples had an abnormal resistance after the additional impact resistance test, the spark plug samples were further additionally subjected to the same impact resistance test for 30 minutes. The spark plug sample was given a score of 8 points when one or more out of the ten spark plug samples had an abnormal resistance after the further additional impact resistance test.

(4) The spark plug sample was given a score of 10 points when none of the ten spark plug samples had an abnormal resistance even after the further additional impact resistance test.

### Samples of No. 1 to 7

The spark plug samples of No. 1 to 5 were of the same structure as the spark plug 100 of the above exemplary embodiment, but were different from one another in the number of wire turns of the second resistor 22. In each spark plug sample, the second resistor 22 had a core formed of alumina (non-magnetic material) with an outer diameter of 2.0 mm and a wire formed of stainless steel with a diameter of 10 μm and wound helically around the core and had a resistance 50Ω and an axial length of 10 mm. The number of wire turns of the second resistor 22 was 20 in the spark plug sample of No. 1; 30 in the spark plug sample of No. 2; 80 in the spark plug sample of No. 3; 100 in the spark plug sample of No. 4; and 400 in the spark plug sample of No. 5. In each spark plug sample, the first resistor 15 was formed using carbon black as the conductive material, B₂O₃—SiO₂ glass as the glass material and ZnO₂ as the ceramic material; and the axial length of the first resistor 15 was 8 mm. The compositions and sizes of the other structural members were the same in the spark plug samples of No. 1 to 5. (As to the after-mentioned spark plug samples of No. 6 to 26, there will be omitted a detailed explanation of the same parts and portions as those of the spark plug samples of No. 1 to 5.)

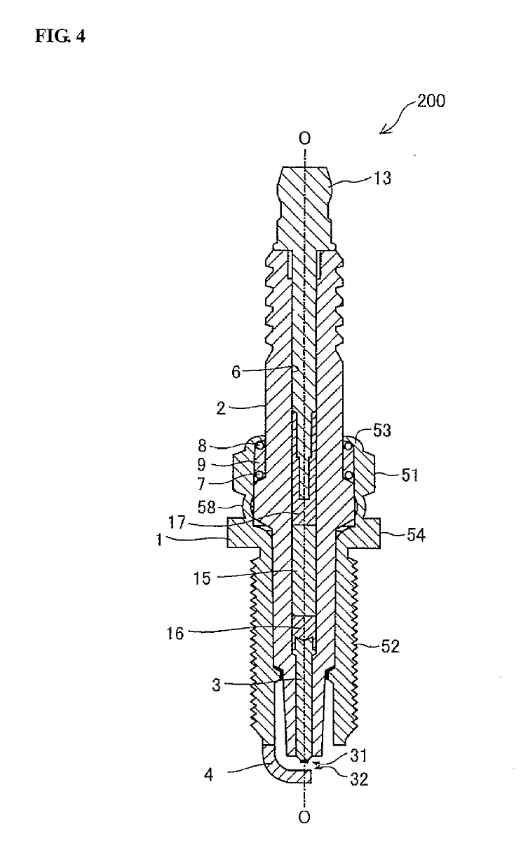

The spark plug sample of No. 6 was formed as a comparative spark plug 200 of FIG. 4. In FIG. 4, the same parts and portions of the spark plug 200 as those of the spark plug 100 are designated by the same reference numerals. As shown in FIG. 4, the spark plug 200 was provided only with the first resistor 15 and was not provided with the second resistor 22.

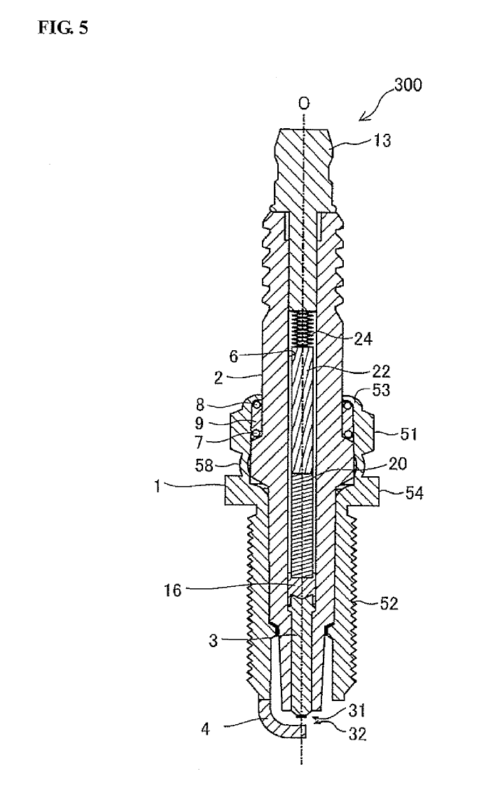

The spark plug sample of No. 7 was formed as another comparative spark plug 300 of FIG. 5. In FIG. 5, the same parts and portions of the spark plug 300 as those of the spark plug 100 are designated by the same reference numerals. As shown in FIG. 5, the spark plug 300 was provided only with the second resistor 22 and was not provided with the first resistor 15.

The specifications and test results of the spark plug samples of No. 1 to 7 are shown in TABLE 1.

TABLE 1

| | | First | Second resistor | | | |
|---|---|---|---|---|---|---|
| | | resistor | | | Wire | |
| Sample | | Length | Resistance | Wire | diameter | Number of |
| No. | Structure | (mm) | (Ω) | material | (μm) | wire turns |
| 1 | first resistor + | 8.0 | 50 | stainless | 10 | 20 |
| 2 | second resistor | | | steel | | 30 |
| 3 | | | | | | 80 |
| 4 | | | | | | 100 |
| 5 | | | | | | 400 |
| 6 | first resistor | | — | — | — | — |
| | only | | | | | |
| 7 | second resistor | — | 50 | stainless | 40 | 300 |
| | only | | | steel | | |

| | Second resistor | | | | | |
|---|---|---|---|---|---|---|
| | Core outer | Core | | | Radio noise | |
| Sample | diameter | material | Length | | control | Impact |
| No. | (mm) | properties | (mm) | Durability | performance | resistance |
| 1 | 2.0 | non- | 10 | 10 | 0 | 10 |
| 2 | | magnetic | | | 6 | |
| 3 | | | | | 8 | |
| 4 | | | | | 10 | |
| 5 | | | | | 10 | |
| 6 | — | — | — | | 0 | |
| 7 | 2.0 | non- | 10 | | 0 | |
| | | magnetic | | | | |

It is seen from comparison between the test results of the spark plug sample of No. 1 to 5, the spark plug sample of No. 6 and the spark plug sample of No. 7 in TABLE 1 that the radio noise control performance of the spark plug was significantly improved by the combined use of the first resistor 15 and the second resistor 22. In particular, the spark plug had excellent radio noise control performance when the number of wire turns of the second resistor 22 was 30 or more as is seen from TABLE 1. The reason for this is assumed that it was possible to secure the sufficient inductance component of the second resistor 22 for improvement in radio noise control performance by setting the number of wire turns of the second resistor 22 to 30 or more.

### Samples of No. 8 to 10

The spark plug samples of No. 8 to 10 were of the same structure as the spark plug 100 of the above exemplary embodiment, but were different from each other in the number of wire turns of the second resistor 22. The number of wire turns of the second resistor 22 was 20 in the spark plug sample of No. 8; 30 in the spark plug sample of No. 9; and 50 in the spark plug sample of No. 10. The spark plug samples of No. 8 to 10 were structurally the same as those of No. 1 to 5 except that the core was formed of Ni—Zn ferrite (ferromagnetic material).

The specifications and test results of the spark plug samples of No. 8 to 10 are shown in TABLE 2.

TABLE 2

| | | First | Second resistor | | | |
|---|---|---|---|---|---|---|
| | | resistor | | | Wire | |
| Sample | | Length | Resistance | Wire | diameter | Number of |
| No. | Structure | (mm) | (Ω) | material | (μm) | wire turns |
| 8 | first resistor + | 8.0 | 50 | stainless | 10 | 20 |
| 9 | second resistor | | | steel | | 30 |
| 10 | | | | | | 50 |

| | Second resistor | | | | | |
|---|---|---|---|---|---|---|
| | Core outer | Core | | | Radio noise | |
| Sample | diameter | material | Length | | control | Impact |
| No. | (mm) | properties | (mm) | Durability | performance | resistance |
| 8 | 2.0 | ferro | 10 | 10 | 8 | 10 |
| 9 | | magnetic | | | 10 | |
| 10 | | | | | | |

It is seen from TABLE 2 that, even in the case where the core was formed of ferromagnetic material, the radio noise control performance of the spark plug was significantly improved when the number of wire turns of the second resistor 22 was 30 or more.

### Samples of No. 11 to 13

The spark plug samples of No. 11 to 13 were of the same structure as the spark plug 100 of the above exemplary embodiment, but were different from each other in the axial length and wire diameter of the second resistor 22. The axial length of the second resistor 22 was 3 mm in the spark plug sample of No. 11; 5 mm in the spark plug sample of No. 12; and 10 mm in the spark plug sample of No. 13. The wire diameter of the second resistor 22 was 1 μm in the spark plug sample of No. 11; 3 μm in the spark plug sample of No. 12; and 5 μm in the spark plug sample of No. 13. In the spark plug samples of No. 11 to 13, the core of the second resistor 22 was formed of the same ferromagnetic material as in the spark plug samples of No. 8 to 10. It is herein noted that the spark plug sample of No. 10 was the same as the spark plug sample of No. 9. Further, the axial length of the seal contact member 20 was varied depending on the axial length of the second resistor 22 in the spark plug samples of No. 11 to 13.

The specifications and test results of the spark plug samples of No. 11 to 13 are shown in TABLE 3.

TABLE 3

| | | First | Second resistor | | | |
|---|---|---|---|---|---|---|
| | | resistor | | | Wire | |
| Sample | | Length | Resistance | Wire | diameter | Number of |
| No. | Structure | (mm) | (Ω) | material | (μm) | wire turns |
| 11 | first resistor + | 8.0 | 50 | stainless | 1 | 30 |
| 12 | second resistor | | | steel | 5 | |
| 13 (9) | | | | | 10 | |

| | Second resistor | | | | | |
|---|---|---|---|---|---|---|
| | Core outer | Core | | | Radio noise | |
| Sample | diameter | material | Length | | control | Impact |
| No. | (mm) | properties | (mm) | Durability | performance | resistance |
| 11 | 2.0 | ferro | 3 | 10 | 10 | 8 |
| 12 | | magnetic | 5 | | | 10 |
| 13 (9) | | | 10 | | | |

It is seen from TABLE 3 that the spark plug had very good impact resistance when the axial length of the second resistor 22 was 5 mm or longer. The reason for this is assumed that, even though the wire diameter of the second resistor 22 was made larger, it was possible to ensure the desired number of wire turns of the second resistor 22 by setting the axial length of the second resistor 22 to 5 mm or longer.

### Samples of No. 14 to 16

The spark plug samples of No. 14 to 16 were of the same structure as the spark plug 100 of the above exemplary embodiment, but were different from each other in the core outer diameter of the second resistor 22. The core outer diameter of the second resistor 22 was 1.2 mm in the spark plug sample of No. 14; 1.5 mm in the spark plug sample of No. 15; and 2.0 mm in the spark plug sample of No. 16. The wire diameter of the second resistor 22 was 1 μm in the spark plug sample of No. 11; 3 μm in the spark plug sample of No. 12; and 5 μm in the spark plug sample of No. 13. In the spark plug samples of No. 14 to 16, the core of the second resistor 22 was also formed of the same ferromagnetic material as in the spark plug samples of No. 8 to 10. It is herein noted that the spark plug sample of No. 16 was the same as the spark plug sample of No. 10.

The specifications and test results of the spark plug samples of No. 14 to 16 are shown in TABLE 4.

TABLE 4

| | | First | Second resistor | | | |
|---|---|---|---|---|---|---|
| | | resistor | | | Wire | |
| Sample | | Length | Resistance | Wire | diameter | Number of |
| No. | Structure | (mm) | (Ω) | material | (μm) | wire turns |
| 14 | first resistor + | 8.0 | 50 | stainless | 10 | 50 |
| 15 | second resistor | | | steel | | |
| 16 (10) | | | | | | |

| | Second resistor | | | | | |
|---|---|---|---|---|---|---|
| | Core outer | Core | | | Radio noise | |
| Sample | diameter | material | Length | | control | Impact |
| No. | (mm) | properties | (mm) | Durability | performance | resistance |
| 14 | 1.2 | ferro | 10 | 10 | 8 | 10 |
| 15 | 1.5 | magnetic | | | 10 | |
| 16 (10) | 2.0 | | | | | |

It is seen from TABLE 4 that the spark plug had excellent radio noise control performance when the core outer diameter of the second resistor 22 was 1.5 mm or larger. The reason for this is assumed that it was possible to secure the higher inductance component by setting the core outer diameter of the second resistor 22 to 1.5 or larger.

### Samples of No. 17 to 21

The spark plug samples of No. 17 to 21 were of the same structure as the spark plug 100 of the above exemplary embodiment, but were different from each other in the resistance of the second resistor 22 (as measured at 20° C.). The resistance of the second resistor 22 was 2000Ω in the spark plug sample of No. 17; 1000Ω in the spark plug sample of No. 18; 100Ω in the spark plug sample of No. 19; 50Ω in the spark plug sample of No. 20; and 10Ω in the spark plug sample of No. 21. Herein, the resistance of the second resistor 22 was adjusted by varying the material and diameter of the wire. The wire of the second resistor 22 was formed of tungsten alloy in the spark plug samples of No. 17 and 18; and stainless steel in the spark plug samples of No. 19 to 21. The wire diameter of the second resistor 22 was 20 μm in the spark plug sample of No. 17; 28 μm in the spark plug sample of No. 18; 7 μm in the spark plug sample of No. 19; 10 μm in the spark plug sample of No. 20; and 22 μm in the spark plug sample of No. 21. In the spark plug samples of No. 17 to 21, the core of the second resistor 22 was also formed of the same ferromagnetic material as in the spark plug samples of No. 8 to 10. It is herein noted that the spark plug sample of No. 20 was the same as the spark plug sample of No. 10.

The specifications and test results of the spark plug samples of No. 17 to 21 are shown in TABLE 5.

TABLE 5

| | | First | Second resistor | | | |
|---|---|---|---|---|---|---|
| | | resistor | | | Wire | |
| Sample | | Length | Resistance | Wire | diameter | Number of |
| No. | Structure | (mm) | (Ω) | material | (μm) | wire turns |
| 17 | first resistor + | 8.0 | 2000 | W alloy | 20 | 50 |
| 18 | second resistor | | 1000 | | 28 | |
| 19 | | | 100 | stainless | 7 | |
| 20 (10) | | | 50 | steel | 10 | |
| 21 | | | 10 | | 22 | |

| | Second resistor | | | | | |
|---|---|---|---|---|---|---|
| | Core outer | Core | | | Radio noise | |
| Sample | diameter | material | Length | | control | Impact |
| No. | (mm) | properties | (mm) | Durability | performance | resistance |
| 17 | 2.0 | ferro | 10 | 0 | 10 | 10 |
| 18 | | magnetic | | 10 | | |
| 19 | | | | | | |
| 20 (10) | | | | | | |
| 21 | | | | | | |

It is seen from TABLE 5 that the spark plug had very good durability when the resistance of the second resistor 22 was 1000Ω (1 kΩ) or lower. The reason for this is assumed that it was possible to prevent degradation or breakage of the wire caused by heat generation of the second resistor 22 and suppress the passage of electric current between the adjacent wire turns of the second resistor 22 by setting the resistance of the second resistor 22 to 1 kΩ or lower.

### Samples of No. 22 to 26

The spark plug samples of No. 22 to 26 were of the same structure as the spark plug 100 of the above exemplary embodiment, but were different from each other in the axial length of the first resistor 15. The axial length of the first resistor 15 was 2.8 mm in the spark plug sample of No. 22; 3.0 mm in the spark plug sample of No. 23; 8.0 mm in the spark plug sample of No. 24; 12.0 mm in the spark plug sample of No. 25; and 13.0 mm in the spark plug sample of No. 26. In the spark plug samples of No. 22 to 26, the core of the second resistor 22 was also formed of the same ferromagnetic material as in the spark plug samples of No. 8 to 10. It is herein noted that the spark plug sample of No. 24 was the same as the spark plug sample of No. 10. Further, the axial length of the seal contact member 20 was varied depending on the axial length of the first resistor 15 in the spark plug samples of No. 22 to 26. In the production of the spark plug samples of No. 22 to 26, the relationship of the amount of the raw material powder used for formation of the first resistor 15 and the axial length of the first resistor 15 was investigated in advance so that the through hole 6 was filled with the required amount of the raw material powder to form the first resistor 15 with the desired axial length.

The specifications and test results of the spark plug samples of No. 22 to 26 are shown in TABLE 6.

TABLE 6

| | | First | Second resistor | | | |
|---|---|---|---|---|---|---|
| | | resistor | | | Wire | |
| Sample | | Length | Resistance | Wire | diameter | Number of |
| No. | Structure | (mm) | (Ω) | material | (μm) | wire turns |
| 22 | first resistor + | 2.8 | 50 | stainless | 10 | 50 |
| 23 | second resistor | 3.0 | | steel | | |
| 24 (10) | | 8.0 | | | | |
| 25 | | 12.0 | | | | |
| 26 | | 13.0 | | | | |

| | Second resistor | | | | | |
|---|---|---|---|---|---|---|
| | Core outer | Core | | | Radio noise | |
| Sample | diameter | material | Length | | control | Impact |
| No. | (mm) | properties | (mm) | Durability | performance | resistance |
| 22 | 2.0 | ferro | 10 | 10 | 8 | 10 |
| 23 | | magnetic | | | 10 | |
| 24 (10) | | | | | | |
| 25 | | | | | | |
| 26 | | | | | | 8 |

It is seen from TABLE 6 that the spark plug had excellent radio noise control resistance when the axial length of the first resistor 15 was 3 mm or longer. The reason for this is assumed that it was possible to suppress the passage of electric current through the insulating material part of the first resistor 15 by setting the axial length of the first resistor 15 to 3 mm or longer. In particular, the spark plug had very good impact resistance when the axial length of the first resistor 15 was 12 mm or shorter as is seen from TABLE 6.

The entire contents of Japanese Patent Application No. 2014-095105 (filed on May 2, 2014) are herein incorporated by reference.

The present invention is not limited to the above specific embodiment and modification examples and can be embodied in various forms without departing from the scope of the present invention. For example, it is possible to appropriately replace or combine any of the technical features mentioned above in “Summary of the Invention” and “Description of the Embodiments” in order to solve part or all of the above-mentioned problems or achieve part or all of the above-mentioned effects. Any of these technical features, if not explained as essential in the present specification, may be eliminated as appropriate. The scope of the invention is defined with reference to the following claims.

Having described the invention, the following is claimed:

1. A spark plug comprising:
an insulator having a through hole formed therein in an axis direction;
a center electrode disposed in the through hole, with a front end portion of the center electrode protruding from a front end of the insulator;
a metal terminal disposed in the through hole, with a rear end portion of the metal terminal protruding from a rear end of the insulator;
a first resistor containing at least a conductive material and a glass material and located between the center electrode and the metal terminal within the through hole;
a pair of front and rear conductive glass seal layers located adjacent to front and rear ends of the first resistor, respectively;
a seal contact member located adjacent to a rear end of the rear conductive glass seal layer;
a second resistor located adjacent to a rear end of the seal contact member and provided in the form of a wire-wound resistor having 30 or more turns of wire; and
a conductive elastic member located between the second resistor and the metal terminal.

2. The spark plug according to claim 1, wherein the first resistor has a length of 3 mm to 12 mm in the axis direction.

3. The spark plug according to claim 1, wherein the second resistor has 100 turns or more of wire.

4. The spark plug according to claim 1, wherein the second resistor has a core made of a ferromagnetic material and extending through the turns of the wire in the axis direction.

5. The spark plug according to claim 4, wherein the ferromagnetic material contains iron oxide.

6. The spark plug according to claim 1, wherein a front end portion of the second resistor and a rear end portion of the seal contact member have respective engagement parts engageable with each other.

7. The spark plug according to claim 1, wherein the second resistor has a resistance of 1 kΩ or lower.
